(19) United States
(12) Patent Application Publication
(10) Pub. No.: US 2010/0159895 A1
(43) Pub. Date: Jun. 24, 2010

(54) PROVIDING ENHANCED EDGE SERVICES TO DEVICES IN FEMTOZONES

(75) Inventors: Michael Brett Wallis, McKinney, TX (US); Zeev V. Lubenski, Richardson, TX (US); Gary Lee Brannick, Plano, TX (US)

Correspondence Address: FISH & RICHARDSON P.C., P.O. BOX 1022, MINNEAPOLIS, MN, 55440-1022, US

(73) Assignee: MAVENIR SYSTEMS, INC., Richardson, TX (US)

(21) Appl. No.: 12/510,992

(22) Filed: Jul. 28, 2009

Related U.S. Application Data
(60) Provisional application No. 61/084,864, filed on Jul. 30, 2008.

(51) Int. Cl. H04W 4/00

(52) U.S. Cl. 455/414.1

(57) ABSTRACT

The present disclosure is directed to providing enhanced edge services to devices in femtozones. In some implementations, a method includes receiving a request associated with a communication session with a femtozone area. The femtozone area includes a plurality of communication devices communicably coupled to a femtocell device and associated in a service group. One or more enhanced services available to the service group is identified in response to at least the request. A command to execute at least one of the one or more services for the communication devices is transmitted to at least the femtocell device associated with the femtozone area.

### CLAIM OF PRIORITY

This application claims priority under 35 USC §119(e) to U.S. Provisional Application No. 61/084,864, filed Jul. 30, 2008, the entire disclosure of which is incorporated herein by reference.

### TECHNICAL FIELD

This invention relates to network communication and, more particularly, to providing enhanced edge services to devices in femtozones.

### BACKGROUND

Communication networks include wired and wireless networks. Example wired networks include the Public Switched Telephone Network (PSTN) and the Internet. Example wireless networks include cellular networks as well as unlicensed wireless networks that connect to wired networks. Calls and other communications may be connected across wired and wireless networks.

Cellular networks are radio networks made up of a number of radio cells, or cells, that are each served by a base station or other fixed transceiver. The cells are used to cover different areas in order to provide radio coverage over a wide area. When a cell phone moves from place to place, it is handed off from cell to cell to maintain a connection. The handoff mechanism differs depending on the type of cellular network. Example cellular networks include Global System for Mobile Communication (GSM) protocols, Code Division Multiple Access (CDMA) protocols, Universal Mobile Telecommunications System (UMTS), and others. Cellular networks communicate in a radio frequency band licensed and controlled by the government.

Unlicensed wireless networks are typically used to wirelessly connect portable computers, PDAs and other computing devices to the internet or other wired network. These wireless networks include one or more access points that may communicate with computing devices using an 802.11 and other similar technologies.

### SUMMARY

The present disclosure is directed to providing enhanced edge services to devices in femtozones. In some implementations, a method includes receiving a request associated with a communication session with a femtozone area. The femtozone area includes a plurality of communication devices communicably coupled to a femtocell device and associated in a service group. One or more enhanced services available to the service group is identified in response to at least the request. A command to execute at least one of the one or more services for the communication devices is transmitted to at least the femtocell device associated with the femtozone area.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating an example communication system in accordance with some implementations of the present disclosure;

FIG. 2 is an example signal path in the system of FIG. 1;

FIG. 3 is another example signal path in the system of FIG. 1;

FIG. 4 is an example call flow for providing enhance edge services using the system of FIG. 1; and

FIG. 5 is a flow diagram illustrating an example method for providing enhanced edge services.

Like reference symbols in the various drawings indicate like elements.

### DETAILED DESCRIPTION

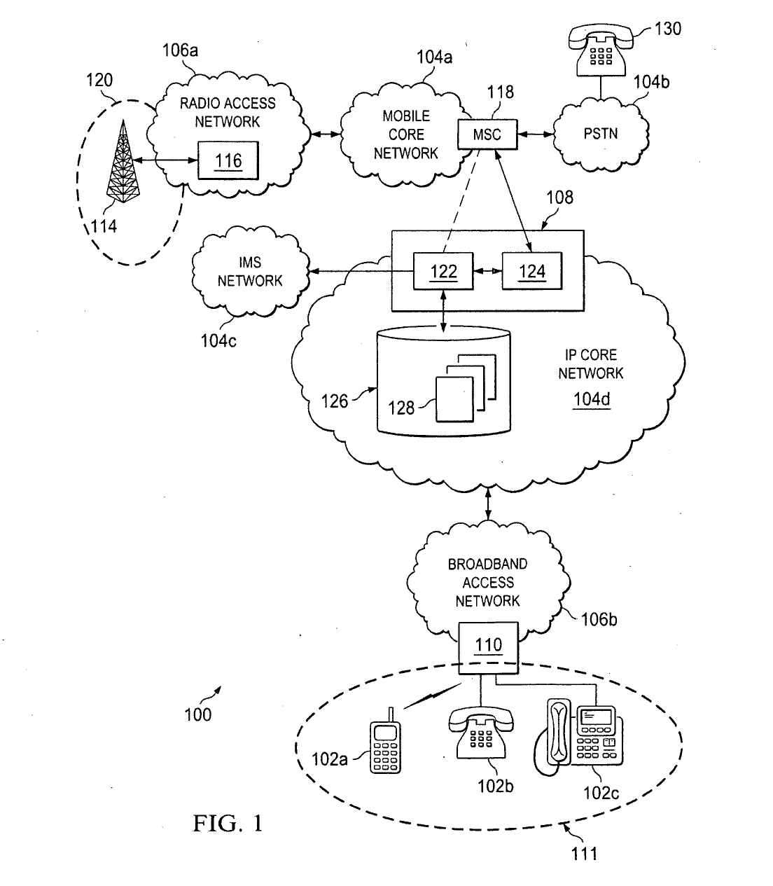

FIG. 1 is an example communication system 100 for providing services to different devices in a femtozone area. For example, the system 100 may execute enhanced edge services for a plurality of different types of communication devices in a femtozone area such as transparently switching a communication session between logically associated devices. In general, femtozone areas are geographic locations associated with low-powered (e.g., 1 Watt or less) cellular radio systems, or femtocells, such that cellular mobile devices can wirelessly communicate using cellular radio technologies with femtocell devices connect to, for example, broadband networks. In addition to wireless devices, the femtozone area may include or otherwise be associated with wired devices such as Session Initiation Protocol (SIP) devices, Plane Old Telephone Service (POTS) devices, and/or others. In some implementations, the femozone area may include wireless devices and wired devices that participate in communication sessions using an Internet Protocol (IP) network. For example, the logically-associated devices may be connected to a single edge device, such as a femtocell device, that routes communications sessions through the IP network. In these implementations, the different communication devices may include one or more of the following: a cellular device, a SIP device, a POTS device, and/or others. In some examples, a SIP device and a POTS device may be wired to a single edge device and a cellular device may be wirelessly connected to the single edge device. As illustrated in the mentioned example, the system 100 may include a device on the edge of an IP network configured to provide edge services to a plurality of different types of devices.

In some examples of providing services, the system 100 may switch a call session between different communication devices such as a cellular device and a POTS device transparent to the other party participating in the session. In other words, the system 100 may execute such edges services, including the underlying session topology, transparent to core network elements such as, for example, Mobile Switching Centers (MSCs). In some implementations, the devices in the femtozone area can be logically associated based, at least in part, on one or more parameters (e.g., user). In some examples, the system 100 may assign or otherwise associate different communication devices to a logical group such that different services may be synchronized between the logically-associated devices. The services may include one or more of the following: substantially simultaneous ringing, sequential ringing, switching calls between logically-associated devices, and/or other services. In some implementations, the system 100 may switch communication sessions between a cellular device in a femtocell and a logically-associated communication device, such as a POTS device, in the associated femtozone area. In some instances, the cellular device may wirelessly communicate with a femtocell device, and the POTS device may be wired to the same femtocell device. In connection with providing the edge services, the POTS and the cellular device may appear as the same device to a cellular core network. In other words, the system 100 may transfer a leg of a communication session between two logically-associated device transparent to participating devices (e.g., MSC). In some implementations, the system 100 may simultaneously ring different types of communication devices in a femtozone area based on a request to initiate a communication session. By managing different logically-associated devices in a femtozone area, the system 100 may provide converged services to a plurality of different communication devices. For example, the system 100 may switch communication sessions between different devices, simultaneously alert different communication devices of requests to initiate a communication session, and/or other services.

At a high level, the system 100, in some implementations, includes communication devices 102a-c, core networks 104a-d, access networks 106a and 106b, a communication node 108, and a femtocell device 110. As for a high level description of the elements, the communication devices 102 participates in communication sessions with the core networks 104. The femtocell device 110 may route communication sessions between the communication devices 102 and the communication node 108. For example, the femtocell device 110 may translate a communication session between a form compatible with the broadband access network 106b and the IP core network 104d and the communication devices 102. The communication node 108 may manage the edge services provided to the communication devices 102 in the femtozone area 111. For example, the communication node 108 may provide enhanced services to the communication devices 102 such as switching sessions between different devices, simultaneous ringing, and/or other services not typically provide by the core networks 104. In some implementations, the communication node 108 may present devices foreign to a core network 104 as a native device 102. For example, the communication node 108 may present a SIP device 102c as a cellular device 102a to the cellular core network 104a. In these examples, the communication node 108 may switch a communication session between the SIP device 102c and the cellular device 102a transparent to the cellular core network 104a. As for a high level description of the operation, the communication node 108 may receive a request to execute one or more enhanced services for at least one of the plurality of logically-associated communication devices 102. For example, the communication node 108 may receive a request to transfer an existing call leg between a communication device 102 and the communication node 108 to a different communication device 102. In response to at least the request, the communication node 108 may establish the call leg with the different communication device 102 and terminate the initial call leg. In some implementations, the provided enhanced services may be transparent to the core networks 104. As previously mentioned, the different types of communication devices 102 may appear as the same communication device 102 to a core network 104.

Turning to a more detailed description of the elements, each communication device 102 comprises an electronic device operable to receive and transmit network communication in the system 100. As used in this disclosure, the communication devices 102 are intended to encompass cellular phones, data phones, pagers, portable computers, SIP phones, POTS devices, smart phones, personal data assistants (PDAs), one or more processors within these or other devices, or any other suitable processing devices capable of communicating information over a wireless and/or wired link to access networks 106. Generally, the communication devices 102 may transmit voice, video, multimedia, text, web content or any other user/client-specific content. In short, device 102 generates requests, responses or otherwise communicates with core networks 104 via access networks 106. For purposes of example, a cellular device 102a, a SIP telephone 102b, and POTS telephone 102c are shown communicating with broadband access network 106b through the femtocell device 110. The illustrated devices 102 are for example purposes only and the system 100 may include some, all or different types of communication devices without departing from the scope of this disclosure. In addition, there may be any number of communication devices 102 communicably coupled to access network 106b using the femtocell device 110.

In the illustrated implementation, the core networks 104 include cellular core network 104a, Public Switched Telephone Network (PSTN) 104b, IP Multimedia Subsystem (IMS) network 104c, and IP core network 104d. The cellular core network 104a typically includes various switching elements, gateways and service control functions for providing cellular services. The cellular core network 104a often provides these services via a number of cellular access networks (e.g., RAN) and also interfaces the cellular system with other communication systems such as PSTN 104b via a MSC 118. In accordance with the cellular standards, the cellular core network 104a may include a circuit switched (or voice switching) portion for processing voice calls and a packet switched (or data switching) portion for supporting data transfers such as, for example, e-mail messages and web browsing. The circuit switched portion includes MSC 118 that switches or connects telephone calls between cellular access network 106a and PSTN 104b or another network, between cellular core networks or others. In case the core network 104a is a GSM core network, the core network 104a can include a packet-switched portion, also known as General Packet Radio Service (GPRS), including a Serving GPRS Support Node (SGSN) (not illustrated), similar to MSC 118, for serving and tracking communication devices 102, and a Gateway GPRS Support Node (GGSN) (not illustrated) for establishing connections between packet-switched networks and communication devices 102. The SGSN may also contain subscriber data useful for establishing and handing over call connections. The cellular core network 104a may also include a home location register (HLR) for maintaining “permanent” subscriber data and a visitor location register (VLR) (and/or an SGSN) for “temporarily” maintaining subscriber data retrieved from the HLR and up-to-date information on the location of those communications devices 102 using a wireless communications method. In addition, the cellular core network 104a may include Authentication, Authorization, and Accounting (AAA) that performs the role of authenticating, authorizing, and accounting for devices 102 operable to access GSM core network 104a. While the description of the core network 104a is described with respect to GSM networks, the core network 104a may include other cellular radio technologies such as UMTS, CDMA, and others without departing from the scope of this disclosure.

PSTN 104b comprises a circuit-switched network that provides fixed telephone services. A circuit-switched network provides a dedicated, fixed amount of capacity (a “circuit”) between the two devices for the duration of a transmission session. In general, PSTN 104b may transmit voice, other audio, video, and data signals. In transmitting signals, PSTN 104b may use one or more of the following: telephones, key telephone systems, private branch exchange trunks, and certain data arrangements. Since PSTN 104b may be a collection of different telephone networks, portions of PSTN 104b may use different transmission media and/or compression techniques. Completion of a circuit in PSTN 104b between a call originator and a call receiver may require network signaling in the form of either dial pulses or multi-frequency tones.

IMS network 104c is a network that enables mobile communication technology to access IP multimedia services. The IMS standard was introduced by the 3rd Generation Partnership Project (3GPP) which is the European 3rd generation mobile communication standard. In general, the IMS standards disclose a method of receiving an IP based service through a wireless and/or a non-wireless communication terminal such as those communication devices 102 which are capable of wireless communications and include an IMS client, for example wireless telephone 102b. To achieve these goals, IMS network 104c may use SIP and, in some implementations, wireless telephone 102b is operable to use the same protocol when accessing services through broadband access network 106b. Although not illustrated, IMS network 104c may include Call Session Control Function (CSCF), Home Subscriber Server (HSS), Application Server (AS), and other elements. CSCF acts as a proxy and routes SIP messages to IMS network components such as AS. HSS typically functions as a data repository for subscriber profile information, such as a listing of the type of services allowed for a subscriber. AS provides various services for users of IMS network 104c, such as, for example, video conferencing, in which case AS handles the audio and video synchronization and distribution to communication devices 102.

As mentioned above, the access networks 106 include RAN 106a and broadband network 106b. RAN 106a provides a radio interface between mobile devices and the cellular core network 104a which may provide real-time voice, data, and multimedia services (e.g., a call) to mobile devices through a macrocell 120. In general, RAN 106a communicates air frames via radio frequency (RF) links In particular, RAN 106a converts between air frames to physical link based messages for transmission through the cellular core network 104a. RAN 106a may implement, for example, one of the following wireless interface standards during transmission: Advanced Mobile Phone Service (AMPS), GSM standards, Code Division Multiple Access (CDMA), Time Division Multiple Access (TDMA), IS-54 (TDMA), General Packet Radio Service (GPRS), Enhanced Data Rates for Global Evolution (EDGE), or proprietary radio interfaces. Users may subscribe to RAN 106a, for example, to receive cellular telephone service, Global Positioning System (GPS) service, XM radio service, etc.

RAN 106a may include Base Stations (BS) 114 connected to Base Station Controllers (BSC) 116. BS 114 receives and transmits air frames within a geographic region of RAN 106a (i.e. transmitted by a cellular device 102e) and communicates with other mobile devices 102 connected to the GSM core network 104a. Each BSC 116 is associated with one or more BS 114 and controls the associated BS 114. For example, BSC 116 may provide functions such as handover, cell configuration data, control of RF power levels or any other suitable functions for managing radio resource and routing signals to and from BS 114. MSC 118 handles access to BSC 116 and communication node 108, which may appear as a BSC 116 to MSC 118. MSC 118 may be connected to BSC 116 through a standard interface such as the A-interface. While the elements of RAN 106a are describe with respect to GSM networks, the RAN 106a may include other cellular technologies such as UMTS, CDMA, and/or others. In the case of UMTS, the RAN 106a may include Node B and Radio Network Controllers (RNC).

The broadband access network 106b and/or the IP network 104d facilitates wireline communication between femtocell device 110 and any other devices. As described, the broadband access network 106b and/or the IP network 104d may communicates IP packets to transfer voice, video, data, and other suitable information between network addresses. In the illustrated implementations, the broadband access network 106b and/or the IP network 104d includes or is otherwise coupled to the femtocell device 110. The femtocell device 110 can include any software, hardware, and/or firmware operable to communicate over a wireless and/or wired link to the communication devices 102. For example, the femtocell device 110 may communicate with the cellular mobile device 102a using a femtocell and communicate with the POTS phone 102c using a wired link. In this example, the femtocell device 110 may wirelessly transmit messages to the mobile device 102a using, for example, UMTS or GSM messages. In some implementations, the femtocell device 110 can translate or otherwise convert between signals compatible with the broadband access network 106b and/or the IP network 104d and messages based on technologies not compatible with the access network 106b and the IP core network 104d (e.g., mobile device 102a, POTS device 102c). In doing so, the femtocell device 110 may establish, maintain, or otherwise provide a communication session between the different communication devices 102 and the communication node 108. In some implementations, the femtocell device 110 may generate IP messages and transmits the IP messages to the communication node 108 via broadband access network 106b and the IP network 104d thereby tunneling non-IP technology through the networks 106b and 104d. In regards to wireless communication, the femtocell devices 110 include a range of 50 meters (m) to 100 m and transmit at a power less than or equal to 1 Watt (W). In addition, the femtocell device 110 may receive from the communication node 108 a messages and transmit the non-IP message to the device 102.

The communication node 108 can include any software, hardware, and/or firmware operable to provide services to the communication devices 102 in the femtozone area. For example, the communication node 108 may provide both core-network services and enhanced services to the communication devices 102 connected to the femtocell device 110 through a wired and/or wireless connection. As mentioned above, enhanced services may include services to different types of communication devices 102 in the femtozone area. For example, the enhanced services may include switching services between two different types of communication devices and/or executing services substantially simultaneously to different types of communication devices. In addition, the enhanced edge services may include providing services from core networks 104 foreign to the receiving communication device 110. Such services may include one or more of the following: switching call sessions between different communication devices 102, simultaneous ringing of the logically-associated communication devices 102, session mobility services (e.g., push-to-move, push-to-grab), roaming of cellular device 120a to the macrocell 120, presence messaging services, and/or other information. In some implementations, the communication node 108 may provide these services in response to at least an event. An event may include a request from a device 102 currently participating in a call session, a request from a device 102 not participating in a call session, a location update, detection that a user has started a session, detection that a user has ended a session, detection that a user has turned off the device 102, and/or other event. For example, the communication node 108 may switch the call leg from the device 102a to the device 102b in response to at least receiving a request (e.g., selection of a button) from the device 102a. In some implementations, the communication node 108 may perform one or more of the following: receive information (e.g., registration request, location update) from the communication devices 102 through the femtocell device 110; identify services associated with the communication devices 102; identify criteria for evaluating service requests and associated information; execute requested services including transmitting commands to the femtocell device 110 and/or the core networks 104; and/or others. In regards to receiving information, the communication node 108 may receive a request to register one or more communication devices 102 with a logical group in the femtozone area 111. For example, the cell phone 102a, the SIP phone 102b, and/or the POTS phone 102c may each transmit a request to register with a logical group based on one or more parameters. The one or more parameters may include or otherwise identify a location, a femtozone, a user, a femtocell device 110, and/or others. In some implementations, the logical groups can be based on static provisioning, i.e., these X devices are in a group. In connection with updating and/or generating a logical group, the communication node 108 may identify enhanced services available to the group and/or criteria for providing the services. In general, communication node 108 may be an integrated and/or stand alone unit and, in addition, may be part of a rack or system. In some implementations, communication node 108 comprises a system. A system may be a single node, a plurality of nodes, or a portion of one or more nodes. A system may be distributed and may cross network boundaries. In the illustrated implementation, the communication node 108 includes an AP service node 122 for providing enhanced services and a Media Gateway (MGW) 124 for internetworking the access network 106b with the core networks 104.

The AP service node 122 can include any software, hardware, and/or firmware configured to provide enhanced services to the communication devices 102 in the femtozone area. For example, the AP service node 122 may switch communication sessions between different types of communication devices 102 based, at least in part, on subscriber profiles. In some implementations, the service node 122 may execute one or more of the following: receive a request for enhanced services; identify subscriber profile including associated logical group and evaluation criteria; determine whether the criteria is satisfied based, at least in part, on the request; transmit one or more commands to the femtocell device 110 and/or the core networks 104 in response to at least the request; and/or other services. In regards to receiving request, the service node 122 may receive a request from communication devices 102 and/or core networks 104. For example, the communication node 108 may receive a request to initiate a call with a device 102 from a POTS telephone 130 through the PSTN 104b and, in response to the initiation request, execute a service (e.g., sequential ringing) in the devices 102 in the femtozone area 111. In another example, the communication node 108 may receive a request from a device 102 to provide services to an existing call session with the femtozone area 111. In this example, the requesting device 102 may be currently participating in the communication session and/or may not be participating in the communication session. In some implementations, the service node 122 may provide edge services in response to at least an event. For example, the service node 122 may initiate substantially simultaneous ring in at least a subset of the different devices 102 in response to at least an incoming call from the POTS phone 130. As for subscriber profiles, the service node 122 may retrieve or otherwise identify subscriber information from, for example, the database 126 and, based on the subscriber information, provide one or more services to the communication devices 102 in accordance with the information. As previously mentioned, enhanced services may include one or more of the following: simultaneous ringing; sequential ringing; session transfers between different devices 102; and/or others.

In providing the services, the service node 122 may transmit commands to the femtocell device 110 and/or core networks 104. For example, the service node 122 may implement a service or synchronize different devices 102 using, for example, the Explicit Call Transfer (ECT) service. By synchronizing the devices 102, the service node 122 may transfer an established communication session between two different types of devices 102 in the femtozone area 111. In some implementations, the service node 122 may execute a Push-to-Move (PTM) feature that enables session mobility between different devices 102 in a pre-defined service group such as a logical group associated with the femtozone area 111. For example, a subscriber (e.g., user of device 102) may select a PTM feature from an active device 102 (e.g., cell phone 102a) and switch the session to a currently idle device (e.g., POTS phone 102c) in the service group by, for example, entering a service code. In this implementation, the service node 122 may automatically transfer a call session to a different device 102 in response to at least the service code. For example, the service node 122 may bridge the target device 102 to the session and invoke, for example, the ECT feature on behalf of the invoking device 102 to transfer the session to the target device 102. Continuing with this example, the service node 122 may synchronize the MSC 118 with the target device 102 using the ECT service. As for the particular services, the communication node 108 may provide one or more services to the logically-associated devices 102 in response to at least certain information satisfying criteria. Such criteria may be based on one or more of the following parameters: a destination device; participating devices; core-network services; a logical group; date; time; location; and/or other parameters. For example, the communication node 108 may receive information identifying at least one of the devices 102 and determine whether a call session can be switched to a different device 102 based, at least in part, on criteria associated with the logical group.

The MGW 124 can include any software, hardware, and/or firmware configured to convert or otherwise internetwork the IP network 104b with other core networks 104. For example, the MGW 124 may translate communication sessions between different networks. In this case, the MGW 124 may translate communication sessions between a form compatible with the PSTN 104b to a form compatible with the IP network 104b. In translating sessions, the MGW 124 may translate between different communication protocols. For example, the MGW 124 may convert communications received from the cellular network 104a to the RTP-based protocol used by the broadband access network 106b and/or the IP network 104d, such as a conversion between circuit-switched bearer and bearer over IP transport.

In addition to the communication node 108, the broadband access network 106b and/or the IP network 104d may include a service database 126 configured to store or at least identify one or more service profiles 128. The service profile 128 include any parameters, variables, policies, instructions, settings, rules and/or directives for providing one or more enhanced services to the communication devices 102 in the femtozone area 111. For example, each service profile 128 may be associated with a service group of the femtozone area 111 and identify enhanced services available to the associated devices 102. In some implementations, each service profile 128 may identify one or more of the following parameters: a device identifier, one or more logical groups, a service type, a location, subscribed services, criteria for providing services, authentication information, service timers, and/or others. The service profile 128 may include or otherwise identify commands for providing enhanced services that are compatible with the femtocell device 110 and/or core networks 104. For example, the service profile 128 may include or otherwise identify commands used to execute enhanced services using ECT commands such as switching a session between devices 102. In addition, the database 126 may locally store authentication information used to verify access to enhanced services for specific devices 102. The authentication information may be associated with subscriber services. In some instances, authentication information may be provided to the node 108 as an access key for gaining admission to the services and/or technologies provided in a service subscription. The subscription services may be based on any appropriate parameter such as a specific device 102, specific user of a device 102, a device type, a logical group and/or any other suitable parameters that may distinguish different services. In some implementations, one or more of the profiles 128 can be associated with a specific femtocell device 110, a logical group, a user, a specific device 102, and/or other aspects of the system 100. Profiles 128 may be stored in one or more tables stored in a relational database described in terms of SQL statements or scripts. In other implementations, the profiles 128 may be formatted, stored, or defined as various data structures in text files, Hyperlink Text Markup Language (HTML) files, eXtensible Markup Language (XML) documents, Virtual Storage Access Method (VSAM) files, flat files, Btrieve files, comma-separated-value (CSV) files, internal variables, or one or more libraries. In short, the profiles 128 may comprise one table or file or a plurality of tables or files stored on one computer or across a plurality of computers in any appropriate format. Moreover, the profiles 128 may be local or remote without departing from the scope of this disclosure and store any type of appropriate data.

In one aspect of operation, the communication node 108 receives request associated with a communication session. For example, the request may be to initiate a call session with a communication device 102, a request for an enhanced edge service, and/or other request. In response to at least the request, the communication node 108 may identify one or more profiles 128 to determine devices 102 in a logical group and available services. Based, at least in part, on the profile 128, the communication node 102 may transmit commands to the femtocell device 110 and/or the MSC 118. For example, the communication node 118 may transmit an ECT command to the device 110 to switch the call sessions between devices in the femtozone area 111.

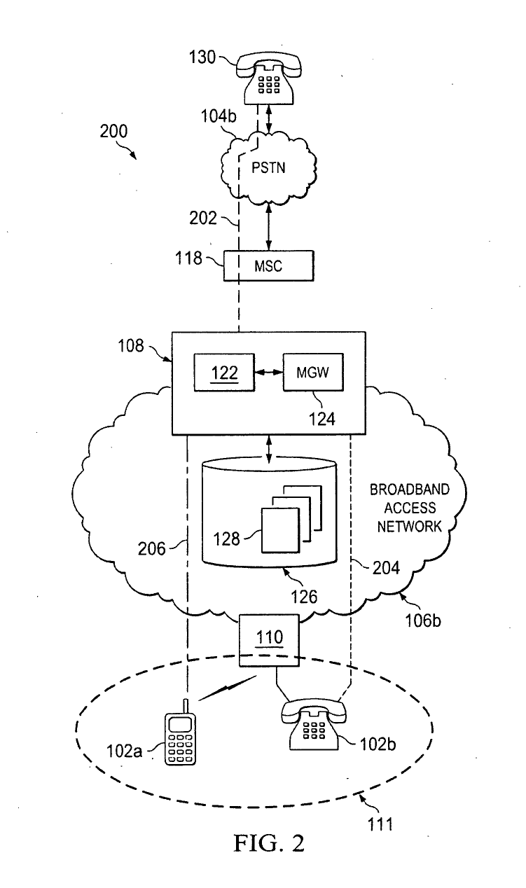

FIG. 2 illustrates a block diagram illustrating signal paths associated with the communication node 108 of FIG. 1. For ease of reference, only some of the elements of the communication system 100 of FIG. 1 are shown. The block diagram of FIG. 2 is described with respect to the system 100 of FIG. 1, but this scenario could be used by other systems. Moreover, the system 100 may use any other suitable implementations for providing enhanced edge services to communication devices 102 in a femtozone area 111.

The system 200 includes a communication node 108 that automatically executes one or more edge services in response to at least an event. For example, the communication node 108 may automatically switch a communication session between two different devices 102 in the femtozone in response to at least a request from one of the devices 102. In some implementations, the communication node 108 may identify instructions based on one or more of the following: device ID, femtocell device ID, criteria, event type (e.g., a request, an incoming call, etc.), a logical group identifier, and/or others. In one aspect of operation, the POTS phone 130 transmits a request to establish a call session with the POTS phone 102b in the femtozone. In connection with the request, a communication session is establish including a first call leg 202 from the POTS 130 to the communication node 108 and a call leg 204 from the communication node 108 to the POTS phone 102b through the femtocell device 110. In response to an event (e.g., a request, session request, satisfaction of predefined criteria), the communication node 108 may establish a third call leg 206 between the node 108 and the cell phone 102a and switch the first call leg 202 to the third call leg 206. In this case, the communication node 108 switches the communication session from the POTS phone 102b to the cell phone 102a. An event may include, for example, a request initiated by the POTS phone 102b, the cell phone 102a, or other device. In the case of executing a Push-To-Move (PTM) feature, the communication node 108 may receive a request from the active device 102b to move the session to the idle device 102a. In the case of executing a Push-To-Grab feature, the communication node 108 may receive a request from the idle device 102a to move the session to the idle device 102a. In connection with switching the services, the communication node 108 may identify one or more subscriber profiles 128 associated with the session. For example, the communication node 108 may identify profiles 128 based, at least in part, on an identified logical group. Using the identified profiles 128, the node 108 may switch the call session between the devices 102. For example, the node 108 may transmits commands to the femtocell device 110 and/or the MSC 118 (e.g., ECT)

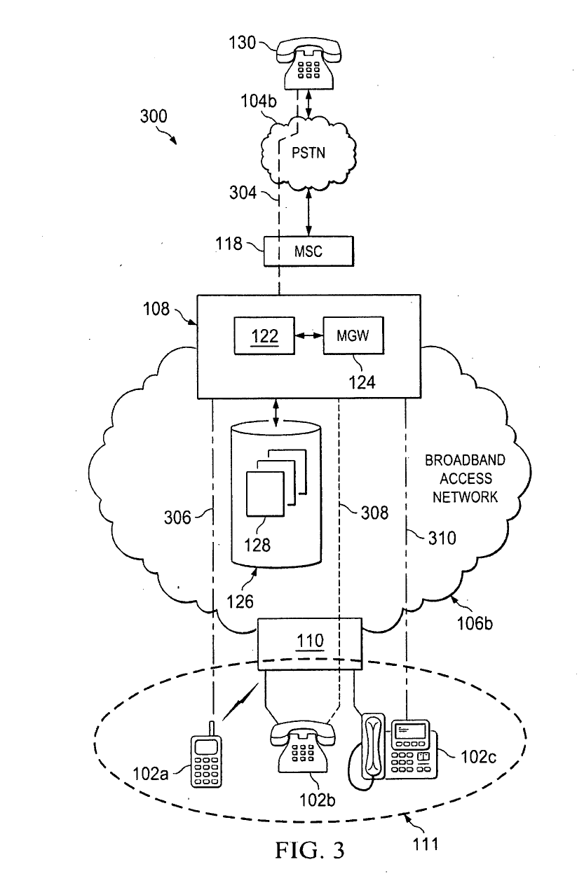

FIG. 3 illustrates a block diagram illustrating signal paths associated with the communication node 108 of FIG. 1. For ease of reference, only some of the elements of the communication system 100 of FIG. 1 are shown. The block diagram of FIG. 3 is described with respect to the system 100 of FIG. 1, but these scenarios could be used by other systems. Moreover, the system 100 may use any other suitable implementations for providing enhanced edge services to communication devices 102 in a femtozone area 111.

The system 300 includes a communication node 108 that automatically executes one or more edge services in connection with registering devices 102 with a logical group. In some implementations, the communication node 108 can initially register one or more devices 102 coupled to the femtocell device 110. For example, the femtocell device 110 may automatically transmit a registration request to the communication node 108 in response to one or more events. A registration event may include a request from a device 102, initially connecting a device 102 with the femtocell device 102, and/or other events. In response to at least receiving a registration request, the service node 122 may automatically generate and/or update one or more subscriber profiles 128 based, at least in part, on the request. For example, the service node 122 may identify a device ID, a logical group, a femtocell device ID, and/or other information. In connection with registering the plurality of devices 102, the communication node 108 may provide substantially simultaneous services to the different devices such as sequential ringing, simultaneous ringing, and/or other services. In one aspect of operation, after registering the communication devices 102, the POTS phone 130 transmits a request to establish a call session with the femtozone area 111. For example, the communication node 108 may identify a logical group, a specific device 102 in the femtozone area 111, and/or other information based, at least in part, on the call request. In response to at least the request, the communication node 108 may identify one or more enhanced edge services using associated subscriber profiles 128. The communication node 108 may transmit commands to the femtocell device 110 in accordance with the identified services. For example, the communication node 108 may transmit commands to initiate simultaneous ringing or sequential ringing with the devices 102 in the femtozone area 111. In response to a device 102 accepting a call request, the femtocell device 110 transmit an acknowledgement to the node 108 and a call session is established between the POTS 130 and the device 102. The communication session includes the call leg 304 and at least one of the call leg 306, the call leg 308 and/or the call leg 310.

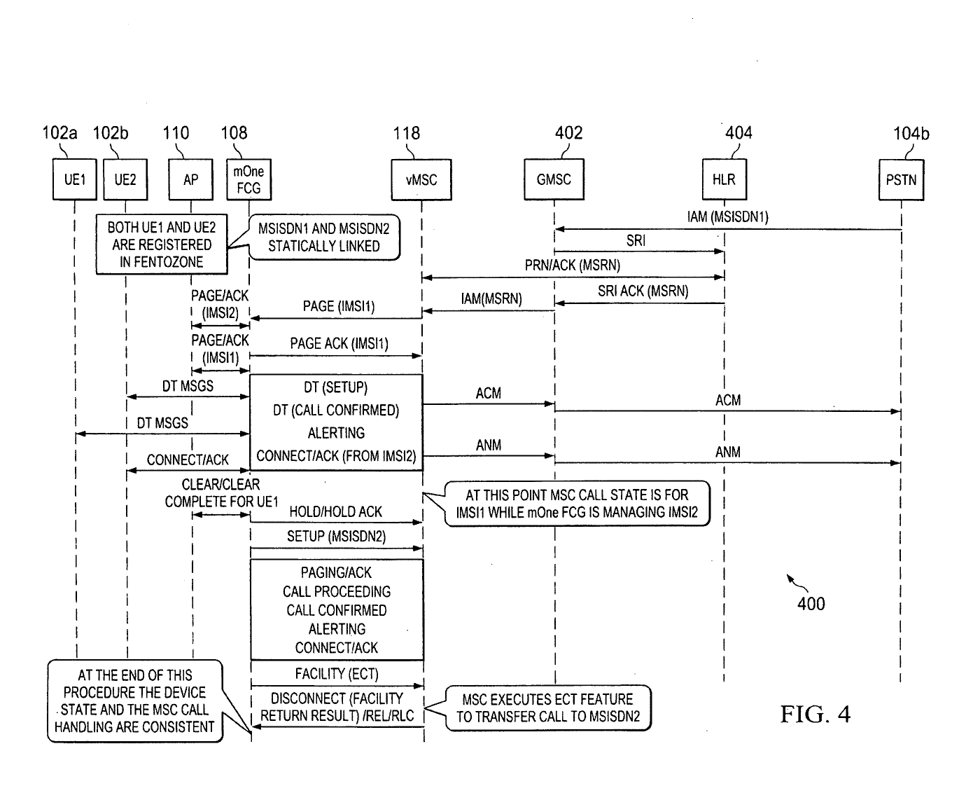

FIG. 4 illustrates an example call flow for executing enhanced edge services in system 100 of FIG. 1. The call flow 400 illustrates a process for switching a call session between a first device 102a and a second device 102b. In this illustrated implementation, the flow includes a GMSC 402 and an HLR 404. A call session is established between the PSTN 104b and the device 102b. In response to at least a request to transfer the call from the idle device 102a, the communication node 108 transfers the call session to the device 102a. As indicated in the call flow 400, the communication node 108 transmits an ECT to switch the call leg with the PSTN 104b to the call leg with the device 102a.

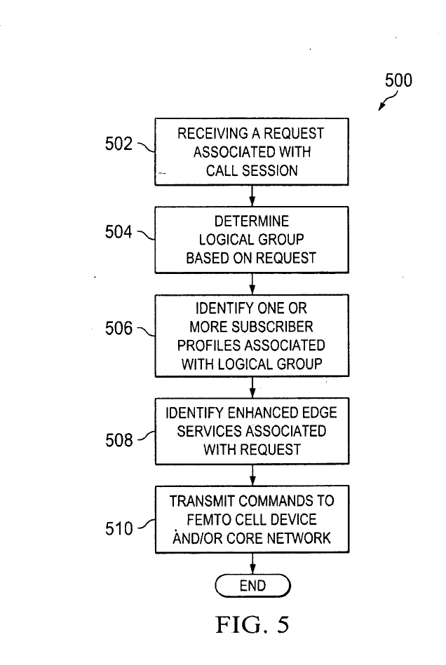

FIG. 5 is a flow chart illustrating an example method 500 for automatically executing edge services for communication devices in a femtozone. The illustrated method is described with respect to system 100 of FIG. 1, but this method could be used by any other suitable system. Moreover, system 100 may use any other suitable techniques for performing these tasks. Thus, many of the steps in this flowchart may take place simultaneously and/or in different orders as shown. System 100 may also use methods with additional steps, fewer steps, and/or different steps, so long as the methods remain appropriate.

Method 500 begins at step 502 where a request associated with a call session is received. For example, the communication node 108 may receive a request to initiate a call session with a device 102 in the femtozone area 111. At step 504, a local group is determined based, at least in part, on the request. In the example, the communication node 108 may identify a service group associated with the request device 102. Next, at step 506, one or more subscribe profiles associated with the logical group is identified. Again in the example, the communication node 108 may identify one or more subscriber profiles 128 associated with the service group. Enhanced edge services available to the service group are identified based on the one or more subscriber profiles at step 508. At step 510, commands are transmitted to the femtocell device and/or the core network to execute the enhanced edge services.

A number of embodiments of the invention have been described. Nevertheless, it will be understood that various modifications may be made without departing from the spirit and scope of the invention.

What is claimed is:

1. A method for providing edge services, comprising:
receiving a request associated with a communication session including a femtozone area, wherein the femtozone area includes a plurality of communication devices communicably coupled to a femtocell device and associated in a service group;
identifying one or more enhanced services available to the service group in response to at least the request; and
transmitting to at least the femtocell device associated with the femtozone area a command to execute at least one of the one or more services for the communication devices.

2. The method of claim 1, wherein the plurality of communication devices comprise a plurality of different types of communication devices.

3. The method of claim 1, wherein the request comprises a request to initiate the communication session with one of the plurality of communication devices.

4. The method of claim 3, wherein the request is received from a Plain Old Telephone System (POTS) device in a Public Switched Telephone Network (PSTN).

5. The method of claim 3, wherein the command executes sequential ringing in the plurality of communication devices in the femtozone area.

6. The method of claim 3, wherein the command executes simultaneous ringing the plurality of communication devices in the femtozone area.

7. The method of claim 1, wherein the request comprises a request from a communication device currently participating in the call session to push the communication session to a different communication device in the femtozone area.

8. The method of claim 1, wherein the request comprises a request from an idle communication device to pull the communication session from a different communication device in the femtozone area.

9. The method of claim 1, wherein the different types of communication devices include a cellular device, a SIP device and a POTS device.

10. The method of claim 1, further comprising:
identifying criteria associated with the one or more services; and
comparing the identified criteria to information included in the request to verify access to the one or more services.

11. The method of claim 1, further comprising transmitting a command to a core network in response to at least the request.

12. The method of claim 11, wherein the command is an Explicit Call Transfer (ECT) command.

13. The method of claim 11, wherein the core-network command is transmitted to a Mobile Switching Center (MSC).

14. A network node, comprising:
memory configured to store information identifying enhanced services for service groups;
one or more processors configured to:
receive a request associated with a communication session with a femtozone area, wherein the femtozone area includes a plurality of communication devices communicably coupled to a femtocell device and associated in a service group;
identify one or more enhanced services available to the service group in response to at least the request; and
transmit to at least the femtocell device associated with the femtozone area a command to execute at least one of the one or more services for the communication devices.

15. The network node of claim 14, wherein the plurality of communication devices comprise a plurality of different types of communication devices.

16. The network node of claim 14, wherein the request comprises a request to initiate the communication session with one of the plurality of communication devices.

17. The network node of claim 16, wherein the request is received from a POTS device in a PSTN.

18. The network node of 16, wherein the command executes sequential ringing in the plurality of communication devices in the femtozone area.

19. The network node of claim 16, wherein the command executes simultaneous ringing the plurality of communication devices in the femtozone area.

20. The network node of claim 14, wherein the request comprises a request from a communication device currently participating in the call session to push the communication session to a different communication device in the femtozone area.

21. The network node of claim 14, wherein the request comprises a request from an idle communication device to pull the communication session from a different communication device in the femtozone area.

22. The network node of claim 14, wherein the different types of communication devices include a cellular device, a SIP device and a POTS device.

23. The network node of claim 14, the processors further operable to:
identify criteria associated with the one or more services; and
compare the identified criteria to information included in the request to verify access to the one or more services.

24. The network node of claim 1, the processors further operable to transmit a command to a core network in response to at least the request.

25. The network node of claim 24, wherein the command is an ECT command.

26. The network node of claim 24, wherein the core-network command is transmitted to a MSC.

27. A system, comprising:
a means for receiving a request associated with a communication session with a femtozone area, wherein the femtozone area includes a plurality of communication devices communicably coupled to a femtocell device and associated in a service group;
a means for identifying one or more enhanced services available to the service group in response to at least the request; and
a means for transmitting to at least the femtocell device associated with the femtozone area a command to execute at least one of the one or more services for the communication devices.
